(19) United States
(12) Patent Application Publication
(10) Pub. No.: US 2011/0022776 A1
(43) Pub. Date: Jan. 27, 2011

(54) DATA RELIABILITY IN STORAGE ARCHITECTURES

(75) Inventors: Andries Hekstra, Eindhoven (NL); Sebastian Egner, Berlin (DE); Ludo Tolhuizen, Waalre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/438,087

(22) PCT Filed: Mar. 20, 2007
(86) PCT No.: PCT/IB2007/050978

§ 371 Date: Feb. 19, 2009

(51) Int. Cl. G06F 12/02; G06F 15/177

(52) U.S. Cl. 711/103; 713/2; 711/E12.008

(57) ABSTRACT

Among other subject matter, storage architectures are provided that store data reliably in connection with a system. The storage architecture (14) includes a first data reliability facility (32), and a second data reliability facility (34), where the second data reliability facility (34) is encoded compliant with the first data reliability facility (32). The storage architecture (14) of this example embodiment also includes a first storage medium (20), the first storage medium (20) storing the second data reliability facility (34).

Advances in digital technology depend, in part, on advances in data storage. Advances in data storage typically take any of a variety of forms. In one example, advances are directed to engineering storage mediums that exploit physical phenomena to store data. Examples of these advances including exploitation of (a) magnetic phenomena to engineer tape drives, floppy disk drives and hard disk drives and (b) optical phenomena to engineer compact disk (CD) and digital versatile disk (DVD) drives. Examples of these advances also include exploitation of phenomena of solid-state physics in engineering memory devices, such as the various implementations of (i) random access memory (RAM), whether dynamic or static, (ii) read only memory (ROM), whether standard ROM, programmable ROM (PROM), erasable and programmable ROM (EPROM), or otherwise, and (iii) flash memory, whether NOR, NAND or otherwise.

In another example, advances are directed to improving storage architecture. Storage architecture may be improved, for example, by employing one or more storage mediums so as to optimize performance in data storage for the system. Doing so generally contemplates giving due regard for each medium's characteristics. It typically contemplates understanding the strengths and weaknesses of each storage medium, so as to maximize those strengths and/or minimize those weaknesses. Moreover, it is completed in the context of engineering the system overall, i.e., effecting the system's purpose, its features/functionalities, and its technical specifications, and otherwise satisfying the system's engineering constraints. Typically, a system's engineering constraints cover technical specifications directed to its storage architecture (e.g., requirements relating to memory capacity, bandwidth, speed and other performance parameters; requirements for additional hardware and/or software, such as memory controllers; requirements for volatile versus non-volatile memory; requirements to enable re-writing any non-volatile memory; speed, frequency and numbers of erase cycles for non-volatile memory; and, power consumption). Typically, a system's engineering constraints also cover commercial parameters, such as development costs, bill of materials, production complexities and attendant costs, and time to market.

Where the system is a personal computer, for example, the storage architecture typically employs a variety of storage mediums. As such, the architecture responds to and exploits, among other things, the computer's relatively large form factor and substantial access to power, and otherwise supports its multi-function purpose. That storage architecture typically includes, e.g.: (a) one or more hard disk drives for long term, local storage of data, such as software programs and/or the inputs/outputs of such programs; (b) one or more optical drives for long term (or permanent), removable storage of data, such as software programs and/or the inputs/outputs of such programs; (c) ROM or other non-volatile storage mediums (e.g., flash memory, particularly for re-writable storage) for to store data, particularly data used by the computer each time it runs (e.g., the computer's BIOS); and (d) a hierarchy of RAM (e.g., main memory and one or more levels of cache) for temporarily storing, and executing, one or more programs, handling input/output data associated with such programs, and/or otherwise storing data, particularly data used in the computer's then-current operations.

Where the system is a cell phone, the storage architecture is implemented responsive to the realities of such portable device. To illustrate, by comparison to a personal computer, a typical cell phone is characterized by relatively meager access to power, substantially smaller form factor, significantly limited chip count and relatively demanding requirements on storage architecture. These and other engineering constraints tend to place substantial demands on the storage architecture, particularly as cell phones become more complex, i.e., as they incorporate new functions and features. For example, because cell phones draw power from batteries, the storage architecture typically uses storage mediums marked by low power consumption. As well, because of phones' increasing variety of features and functionalities (particularly those that are data consumptive) and substantially stable (or even declining) sales prices, the architecture tends increasingly to use storage mediums that deliver enhanced capacity while controlling cost. As well, the architecture preferably also satisfies other engineering constraints.

In that context, cell phone's storage architecture typically employs a variety of storage mediums, but a variety that is more limited than in a personal computer. For example, the architecture may include: (a) NOR flash memory for bootable code storage; (b) some form of low-power dynamic RAM for executing functions and features; and (c) NAND flash memory for long-term storage of application software and data, such as MP3 audio, JPEG photo and other media files. As well, the architecture may be implemented using multi-chip packages, so as to, e.g., accommodate the system's form factor and chip count constraints.

In another example of advances in storage mediums, improvements are directed to implementation of a particular storage medium. To illustrate, in solid-state memory devices, these advances may be directed to improving fabrication, packaging, performance and/or other parameters, including, as examples, capacity, read/write speed, bandwidth, packing density, and/or power consumption.

In a particular example of such advances, improvements are directed to the data reliability associated with a storage medium. Data reliability, in this use, refers to the integrity of the data made available from a particular storage medium, whether that data is a software program, data inputs/outputs of that or another program, or otherwise. As such, improvements in data reliability generally address any shortfalls associated with the integrity of any such data. These shortfalls, generally, arise because storage mediums may be unreliable in receipt, storage or delivery of data. Even so, reliability shortfalls are determined relative to a particular system's engineering constraints, e.g., a particular storage medium may be considered to be more reliable than some others and yet be insufficiently reliability for a specific system wherein engineering constraints set a minimum data reliability threshold above that which the medium can satisfy.

Data reliability shortfalls may be associated with the engineering of storage mediums. Indeed, data reliability shortfalls may be anticipated in cutting edge or future storage mediums, particularly those mediums exploiting physical phenomena which themselves may yield shortfalls or which may have associated error mechanisms. This basis for data reliability shortfalls is present in existing storage mediums, such as conventional NAND flash memory. In NAND flash memory, data is written/erased by exploiting electron tunneling (a well-understood phenomena of solid-state physics), so as to control charge associated with selected floating gates in the memory's transistor array. In this tunneling, however, the energetic electron injection and emission mechanisms tend to generate defects and traps in the gates' oxide layers. Through these defects and traps, electrons improperly transition to or from the transistor(s), resulting in degraded data integrity, and introducing data reliability shortfalls.

Data reliability shortfalls may be addressed simply by employing a different storage medium, e.g., a medium having data reliability at or above the system's minimum threshold.

However, this approach may be undesirable or even unworkable. That is, as previously described, storage mediums typically are selected with due regard for their various strengths and weaknesses, particularly in the context of the satisfying a system's engineering constraints overall. As such, notwithstanding its weakness against a system's data reliability constraint, an unreliable storage medium may be retained because of its strengths against other engineering constraints. Conversely, notwithstanding its strength against the data reliability constraint, a reliable storage medium may be unacceptable because of its weaknesses against other engineering constraints. To illustrate, NAND flash memory may be retained over another, more reliable, non-volatile storage medium, including because engineering constraints require a non-volatile storage medium that is rewritable in system and satisfies bill of material considerations.

In an alternative approach, the storage architecture combines a reliable storage medium with an unreliable storage medium. That is, the storage architecture employs (a) a first storage medium that satisfies the system's data reliability constraint, so as to store particular data (e.g., important programs, inputs/outputs, and/or other data), together with (b) a second storage medium having insufficient data reliability but that addresses one or more other engineering constraints associated with data storage. To illustrate, an architecture may combine NAND flash memory with NOR flash memory, where the NOR flash memory satisfies data reliability constraints so as to store selected programs, inputs/outputs or other data for which data integrity is to be maintained and where the NAND flash memory satisfies engineering constraints directed to, e.g., data capacity, speed, and cost per bit.

Combining storage mediums tends to introduce engineering challenges and otherwise to have drawbacks against engineering constraints. To illustrate, NOR flash tends to have lower capacity than NAND flash, while also tending to increase the bill of materials of the system, either of which characteristics may conflict with the system's engineering constraints. In certain systems, then, the engineering constraints may simply not admit an architecture that combines storage mediums.

In other systems, however, the storage architecture combines storage mediums by addressing the challenges and otherwise minimizing or avoiding the drawbacks against engineering constraints. To illustrate, NOR flash memory is combined in an architecture for its reliability and, even though NOR flash has a cost drawback, that drawback is addressed by employing a relatively small capacity, lower cost unit. Under this approach, however, an engineering challenge is to allocate each bit of the NOR flash memory's limited capacity among various data for reliable storage. That allocation challenge tends to be substantial where the amount of data for reliable storage (e.g., data where such storage is required or preferable) approaches or exceeds the available capacity. Indeed, the allocation challenge may be impossible to meet without opting for a higher capacity NOR flash memory and, thus, conflicting with the bill of materials constraint.

In a combined architecture, a data reliability facility may be employed, implemented in software. When executed, the data reliability facility maintains data integrity, e.g., by detecting and correcting data errors. To do so, the data reliability facility is stored reliably. To illustrate in the context of combined NOR and NAND flash memory, the facility corrects errors in the NAND flash memory's data, but is itself stored in the NOR flash memory. The facility is not be stored in the NAND flash memory, as that storage would subject the facility to the very data errors that the facility is employed to address. Moreover, the facility is preferentially stored in the NOR flash memory over other data, in that the facility enables that other data to be reliably stored in the large capacity, lower cost NAND flash memory.

Data reliability facilities include, for example, error detection and correction algorithms. The performance of these algorithms tends to be a function of the algorithms' detection/correction power and/or complexity and, thus, the algorithms may tend to be storage consumptive. Moreover, as these algorithms and other data reliability facilities become more powerful/complex, they may become all the more storage consumptive in the future.

Data reliability facilities may be implemented as code, hardware or some combination. As such, an unreliable storage medium may be combined with a hardware-implemented data reliability facility, rather than with a reliable software medium that stores a software-implemented facility. Such hardware-implemented data reliability facility may be variously engineered, including as an error detecting/correcting circuit in the system, in a storage architecture module, or in unreliable storage medium. See, e.g., Tanzawa et al., “A Compact On-Chip ECC for Low Cost Flash Memories”, IEEE Journal of Solid-State Circuits, Vol. 32, No. 5, May 1997, pp 662-669 (error correction circuit implemented on a flash memory chip).

However, this hardware implementation has drawbacks. As an example, a hardware-implemented data reliability facility may consume relatively scarce resources. If implemented in the storage architecture or mediums, the data reliability facility may consume relatively scarce module/chip area. See, e.g., Tanzawa et al., referenced above. In any case, the hardware-implemented data reliability facility may also conflict with, or otherwise complicate, for various reasons, one or more system engineering constraints, such as those directed to, e.g., form factor, chip count, bill of materials, power consumption, cost of development, and time to market. As another example, as data reliability facilities increase in complexity, the special purpose hardware implementing the facility may tend to become increasingly complex and otherwise substantial, which in addition to increasing engineering effort, may tend to exacerbate consumption of relatively scarce resources or otherwise introduce or compound challenges associated with satisfying one or more system engineering constraints.

This application is directed to, among other subject matter, storage architectures that store data reliably, in connection with a system. The storage architecture, in one example embodiment, includes a first data reliability facility, and a second data reliability facility, where the second data reliability facility is encoded compliant with the first data reliability facility. The storage architecture of this example embodiment also includes a first storage medium, the first storage medium storing the second data reliability facility.

This application is also directed to, among other subject matter, employ of storage carriers in implementing a system, wherein data is provided reliably. The application is also directed to, among other subject matter, a method for providing reliable data in a system.

These and other embodiments, and other subject matter, are described in more detail in the following detailed descriptions, and in the figures, alone and together. The foregoing is not intended to be an exhaustive list of embodiments and subject matter of the present invention. Persons skilled in the art are capable of appreciating other embodiments and subject matter from the following detailed description, and from the drawings, alone and together.

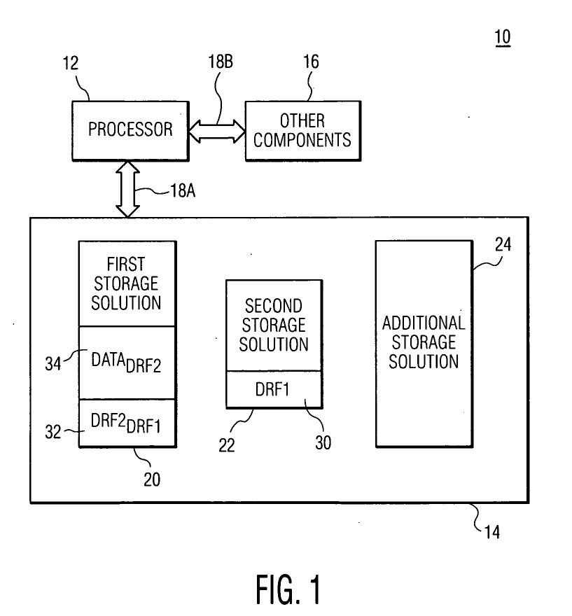

FIG. 1 shows an example embodiment of a system 10.

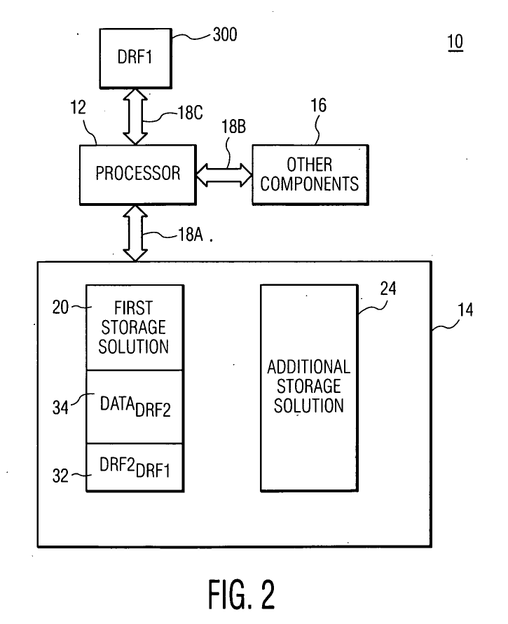

FIG. 2 shows an example embodiment of a system 10.

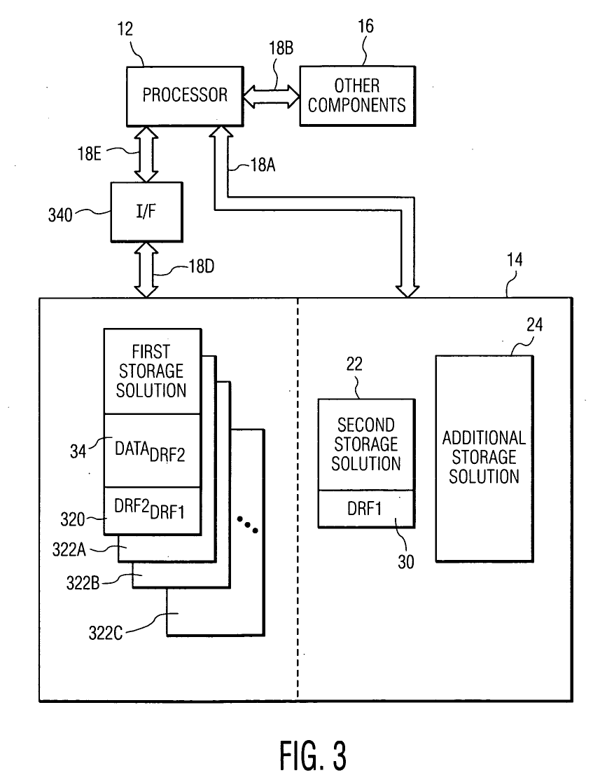

FIG. 3 shows an example embodiment of a system 10.

Example embodiments are shown in FIGS. 1-3, wherein similar features share common or related reference numerals.

Referring to FIG. 1, an example embodiment is shown of a system 10. The system 10 may be any of various products, including, as examples: a stationary computer (e.g., a personal computer), a portable computing device (e.g., a laptop computer, a tablet computer, or personal digital assistant), a stationary consumer electronic device (e.g., an audio or video recorder or playback device, a home stereo, a television, or the like), a portable consumer electronic device (e.g., an audio player, a video camera, a digital camera), a cell phone, or any of a host of other systems that use and/or store data. The system 10 may also be any of various subparts of any such product above, including modules, components, or even chips.

The system 10 includes a processor 12, storage architecture 14, and other components 16. The processor 12 may be variously implemented, including, as examples, using one or more commercial microprocessors, a processor core (e.g., where system 10 is embedded on a single chip or module), or otherwise. Storage architecture 14 and the other components 16, as shown, are coupled to the processor 12 respectively via connection 18A and connection 18B. These connections 18A, 18B may be variously implemented, including, as examples, using a bus architecture, wires, leads, traces or other signal coupling technology as may be appropriate to the system's implementation. These connections 18A, 18B may be implemented using one technology or using different technologies and, when one technology is used, the connections may yet have variations from one another. Although storage architecture 14 and other components 16, as shown, are not directly coupled to one another, in another example embodiment of a system 10, the two may be coupled directly to one another, with or without direct coupling of either with the processor 12.

The other components 16 may be variously implemented, including, as examples, to include one or more input/output buses, other interfaces, special purpose co-processors (e.g., a media processor), signal converters (e.g., analog-to-digital and/or digital-to-analog converters), and/or other special purpose hardware.

Storage architecture 14 may be variously implemented. As shown, storage architecture 14 includes a first storage medium 20, a second storage medium 22 and additional storage medium 24. For purposes of this application, storage mediums include any technology to store data, where data refers to software programs, input/output data for software programs, and any other data stored in or in connection with the system 10. Storage mediums may include, as examples: (a) magnetic based technologies, such as tape drives, floppy disk drives and hard disk drives, and related media; (b) optics based technologies, such as compact disk (CD) and digital versatile disk (DVD) drives, and related media; and (c) solid-state memory devices, such as the various implementations of (i) random access memory (RAM), whether dynamic or static, (ii) read only memory (ROM), whether standard ROM, programmable ROM (PROM), erasable and programmable ROM (EPROM), or otherwise, (iii) electrically erasable and programmable ROM (EEPROM), and (iv) flash memory, whether NOR, NAND or otherwise. Storage mediums are under continual development, both to improve existing mediums and to develop new mediums. This application contemplates that the architecture 14 generally will comprise any such new and/or improved technology.

Storage architecture 14 generally employs one or more storage mediums 20, 22, 24 so as to optimize the system's performance respecting data storage. Storage architecture 14 typically will employ one or more of the storage mediums 20, 22, 24 based on each medium's characteristics, so that each storage medium's strengths are maximized (and/or weaknesses minimized) in order to implement a storage architecture 14 that comports with, and otherwise contributes to satisfying, the system's engineering constraints. That is, storage architecture 14 employs one or more storage mediums 20, 22, 24 toward effecting the system's overall purpose(s), supporting the system's features/functionalities, and satisfying the system's technical specifications.

Typically, a system's engineering constraints cover technical specifications directly or indirectly relating to its storage architecture 14. These technical specifications may include one or more of, as examples: requirements relating to memory capacity, bandwidth, speed and other performance parameters; requirements for additional hardware and/or software, such as memory controllers; requirements for volatile versus non-volatile memory; requirements to enable re-writing any non-volatile memory; speed, frequency and numbers of erase cycles for non-volatile memory; and, power consumption budget for the storage architecture 14. Typically, a system's engineering constraints also cover commercial parameters, such as development costs, bill of materials, production complexities and attendant costs, and time to market, all or any of which may be implicated in implementing storage architecture 14.

If the system 10 is a personal computer, for example, storage architecture 14 generally employs a variety of storage mediums 20, 22, 24. In that employ, storage architecture 14 preferably responds to and exploits, among other things, the computer's relatively large form factor and substantial access to power, and otherwise supports its multi-function purpose. That storage architecture 14 may include, as examples: (a) one or more hard disk drives for long term, local storage of data, such as software programs and/or the inputs/outputs of such programs; (b) one or more optical drives for long term (or permanent), removable storage of data, such as software programs and/or the inputs/outputs of such programs; (c) ROM or other non-volatile storage mediums (e.g., flash memory, particularly for re-writable storage) for to store data, particularly data used by the computer each time it runs (e.g., the computer's BIOS); and (d) a hierarchy of RAM (e.g., main memory and one or more levels of cache) for temporarily storing, and executing, one or more programs, handling input/output data associated with such programs, and/or otherwise storing data, particularly data used in the computer's then-current operations.

If the system is a cell phone, storage architecture 14 preferably is implemented responsive to the purposes and realities of such portable device. To illustrate, by comparison to a personal computer, a typical cell phone is characterized by relatively meager access to power, substantially smaller form factor, significantly limited chip count and relatively demanding requirements on storage architecture. These and other engineering constraints tend to place substantial demands on storage architecture 14, particularly as cell phones become more complex, i.e., as they incorporate new functions and features. For example, because cell phones draw power from batteries, the storage architecture typically uses storage mediums marked by low power consumption. As well, because of phones' increasing features and functionalities (particularly those that are data consumptive) and substantially stable (or even declining) sales prices, storage architecture 14 tends increasingly to use storage mediums that deliver enhanced capacity while controlling cost. As well, the architecture preferably satisfies other engineering constraints.

In that context, a cell phone's storage architecture 14 typically employs a variety of storage mediums 20, 22, 24, but a variety that is more limited than in a personal computer. For example, storage architecture 14 may include, as examples: (a) NOR flash memory for bootable code storage; (b) some form of low-power dynamic RAM for executing functions and features; and (c) NAND flash memory for long-term storage of application software and data, such as MP3 audio, JPEG photo and other media files. As well, storage architecture 14 may be implemented using multi-chip packages, so as to, e.g., accommodate the system's form factor and chip count constraints.

Referring specifically to system 10 of FIG. 1, as previously described, storage architecture 14 employs first storage medium 20, second storage medium 22 and additional storage medium 24, for any of various reasons, which reasons typically are associated with satisfying the particular system's engineering constraints. As one example, storage architecture 14 may employ each storage medium 20, 22, 24 so as to meet one or more selected engineering constraints associated with data storage, e.g., capacity, cost per bit, speed, bandwidth, non-volatility and the like. Typically, the respective, selected engineering constraints satisfied by each storage medium 20, 22, 24 will diverge at least in some relevant way (even if some of the constraints are satisfied by more than one of the mediums 20, 22, 24).

As one example, first storage medium 20 may be employed to satisfy the system's constraints respecting data storage capacity, while second storage medium 22 may be employed to satisfy the system's data reliability constraint. In this example, additional storage medium 24 may be employed for other purposes, such as, for working space in executing programs (e.g., some form of RAM). Moreover, second storage medium 22, satisfying the system's data reliability constraint, may be employed, e.g., to store selected data, such as relatively important programs and/or inputs/outputs, while the first storage medium 22, satisfying the system's capacity constraint, is employed to store other data.

To illustrate this example, storage architecture 14 may employ NAND flash memory as first storage medium 20, together with NOR flash memory as second storage medium 22.

In this illustration, NOR flash memory satisfies the data reliability constraints so as to store selected programs, inputs/outputs or other data for which data integrity is to be maintained. In turn, NAND flash memory satisfies engineering constraints directed to, e.g., data capacity, speed, and cost per bit.

Although storage architecture 14 employs a first storage medium 20 characterized by insufficient data reliability (also referred to herein as the medium being unreliable), the data stored in first storage medium 20 generally may need to be reliable. Data reliability, in this use, refers to the integrity of the data stored and otherwise made available to and from a particular storage medium, whether that data is a software program, data inputs/outputs of that or another program, or otherwise. Data reliability may suffer (i.e., the integrity of the data may have degraded or otherwise be compromised) based on a variety of mechanisms associated with receipt, storage, retrieval or delivery of the data.

Moreover, data reliability typically is relative, e.g., measured against some minimum data reliability threshold associated with the system's engineering constraints. In that case, a storage medium provides sufficient data reliability as long as its data reliability meets or exceeds the system-specified threshold.

Toward providing such reliability, a data reliability facility may be employed. A data reliability facility, as referenced in this application, maintains data integrity. A data reliability facility typically provides, as examples, error detection, error correction and/or other algorithms. When implemented in software, a data reliability facility of some complexity and power will tend to consume substantial storage capacity. (It is understood that, unless otherwise described, a data reliability facility may be implemented in software, in hardware, in some combination of hardware or software, or otherwise, without departing from the subject matter of this application, including, without limitation, the claims hereof.)

Referring again to FIG. 1, and in light of the above discussion of data reliability facilities, if the system 10 is to employ a data reliability facility, that facility preferably is stored in reliable, second storage medium 22. However, as previously described second storage medium 22 may be implemented using a technology characterized by relatively high cost per bit. Accordingly, to satisfy engineering constraints (e.g., a bill of materials target), second storage medium 22 may be implemented to have a relatively limited capacity. As such, second storage medium 22 either may be unable to accommodate a storage-consumptive data reliability facility or, in accommodating that data reliability facility, may be compelled to exclude other important data, e.g., data with substantial, equal or potentially even greater need to be stored reliably.

To illustrate in the context where NAND and NOR flash memory are employed as, respectively, first and second storage mediums 20, 22, a data reliability facility may be desirable to maintain integrity of data associated with otherwise unreliable NAND flash memory. Preferably, the data reliability facility would be stored in the reliable NOR flash memory, so as to preserve the reliability of the facility itself However, the NOR flash memory generally has a high cost per bit (i.e., relative to NAND flash memory). Accordingly, in order to provide reliable memory without falling into conflict with, or otherwise impeding satisfaction of, the system's bill of materials constraints, storage architecture 14 may employ NOR flash memory of relatively small capacity and lower cost.

Doing so, however, tends to inhibit or preclude reliable storage of a storage-consumptive data reliability facility and/or other important data.

Accordingly, as shown in FIG. 1, the system 10 employs first data reliability facility DRF1 30 and second data reliability facility DRF2 32. First data reliability facility DRF1 30 is implemented in software, that software being stored in reliable, second storage medium 22. First data reliability facility DRF1 30 preferably consumes a relatively small portion of the capacity of second storage medium 22.

Second data reliability facility DRF2 32 is implemented in software, that software being stored in unreliable, first storage medium 20. In that storage, second reliability facility DRF2 32 is encoded compliant with the first data reliability facility DRF1 30. That is, second reliability facility DRF2 32 is stored in unreliable first storage medium 20 in a form enabling it to be retrieved using first data reliability facility DRF1 30. When so retrieved, facility DRF2 preferably is stored in additional storage medium 24 for execution, having sufficiently low (e.g., zero or approaching zero) errors so as to properly execute and, thereby, maintain integrity of other data stored in first storage medium 20. As previously described, additional storage medium 24 may be employed as working space in executing programs (e.g., being implemented as some form of RAM).

Second data reliability facility DRF2 32 preferably is sufficiently powerful to maintain integrity of data 34 stored in the first storage medium 20. Data integrity is maintained, generally, in accordance with applicable system engineering constraints. Indeed, such constraints may contemplate a tolerance for some lack of integrity or, conversely, some threshold at or above which data integrity is to be maintained. It is also contemplated that data integrity may vary among data types, system features, system functions, or other variables.

Second data reliability facility DRF2 32 may be variously implemented. Examples include, without limitation: a Reed-Solomon code; a BCH code; and a Hamming code. Variations within each of the above examples are known. As well, the facility 32 may be otherwise implemented within the principles of this application.

Data 34 generally is stored in unreliable first storage medium 20, encoded compliant with facility DRF2. That is, data 34 is stored in medium 20 in a form enabling it to be retrieved using second reliability facility DRF2 32. Typically, the data includes some level of redundancy associated with that encoding. Data 34 may be relatively consumptive of storage capacity.

With both data 34 and second data reliability facility DRF2 32 being stored in first storage medium 20, storage consumption of that medium 20 may be addressed. Typically, however, medium 20 is employed, among other reasons, for its relatively large capacity. As such, even if second data reliability facility DRF2 32 and data 34 are relatively consumptive of the capacity of storage medium 20, that consumption typically is addressed in selecting the medium's capacity. Moreover, generally, storage consumption respecting facility 32 is less relevant to the system's engineering constraints than the facility's provision of sufficient data reliability. Indeed, the system may also include a compression facility for storage of data (e.g., such compression facility being either part of, incorporated in or paired with the second data reliability facility DRF2 32, or otherwise implemented in the system, in hardware, software, or otherwise.)

So as to control its storage consumption (e.g., its size), first data reliability facility DRF1 30 preferably is characterized by relatively low complexity. Even so, facility 30 preferably is sufficiently powerful so as to enable reliable retrieval and execution of second data reliability facility DRF2 32, thus, in turn, enabling the facility 32 to maintain data integrity of data 34.

First data reliability facility DRF1 30 may be variously implemented. Examples include, without limitation: a repetition code and a Hamming code. Variations within each of the above examples are known. As well, the facility 30 may be otherwise implemented within the principles of this application.

In addition to decoding data to provide reliability, either or both data reliability facilities 30, 32 may be implemented to provide encoding of data for (a) storage in any of the storage mediums 20, 22, 24 or otherwise in the storage architecture 14, or (b) output to other components 16, or (c) other purposes. As an example, the first data reliability facility DRF1 30 may be so employed when use of the second data reliability facility DRF2 32 is not required, not appropriate, not viable, or otherwise not desired, for whatever reason.

Referring to FIG. 2, another example embodiment is shown of system 10. Here, second storage medium 22 is omitted. However, such second storage medium 22 may yet be provided in a system 10 otherwise in accordance with this FIG. 2, as shown in FIG. 2 and described hereinbelow.

Even though second storage medium 22 is omitted from the system 10 of FIG. 2, a first data reliability facility DRF1 is provided. By comparison to the example embodiment of FIG. 1, a first data reliability facility DRF1 300 of FIG. 2 is provided in hardware. First data reliability facility DRF1 300 is coupled to the processor 12 via connection 18C. Connection 18C, like connections 18A, 18B, may be variously implemented, including, as examples, using a bus architecture, wires, leads, traces or other signal coupling technology as may be appropriate to the system's implementation. The connections 18A, 18B, 18C may be implemented using one technology or using different technologies, or various combinations of technologies and, when one technology is used for two or more of these connections, such connections may yet have variations from one another.

Such hardware-implemented data reliability facility 300 may be variously engineered. As an example, it may be engineered as an error detecting/correcting circuit in the storage architecture 14 (or any part thereof, including in the chips or modules of the unreliable first storage medium 20) or elsewhere in the system 10. As further examples, it may be engineered in ASIC, FPGA, or other hardware technology.

In any case, facility 300 preferably has characteristics as described with respect to software-implemented facility 30. That is, facility 300 preferably is characterized by relatively low complexity and, as well, facility 300 preferably is sufficiently powerful so as to enable reliable retrieval and execution of second data reliability facility DRF2 32, thus, in turn, enabling the facility 32 to maintain data integrity of data 34.

Generally, addition of hardware in a system may conflict with or otherwise impede satisfaction of one or more engineering constraints of the system. However, here the first data reliability facility 300 preferably is characterized by relatively low complexity. As such, facility 300 may be implemented in relatively few circuits, consuming relatively little module/chip area, drawing relatively low power, requiring relatively little engineering effort or cost, adding little or nothing to each system's bill of materials, and not delaying (or unacceptably delaying) time to market.

Referring to FIG. 3, another example embodiment is shown of system 10. The system of this FIG. 3 follows the system of FIG. 1, except first storage medium 32 is implemented via storage carrier 320. Typically, the storage carrier 320 couples to the processor 12, via an interface 340. This interface 340 may be variously implemented, including, as examples, using hardware, software or some combination of these elements. It is also contemplated that the interface 340 may be omitted from a system 10 in accordance with FIG. 3, without departing from the principles of this application.

The interface 340 is coupled to the processor 12 via connection 18E and to the data carrier 320 via connection 18D. Connections 18D, 18E, like the other connections 18A, 18B, 18C may be variously implemented, including, as examples, using a bus architecture, wires, leads, traces or other signal coupling technology as may be appropriate to the implementation in the system 10 of the interface 340 and storage carrier 320. The connections 18A, 18B, 18C may be implemented using one technology or using different technologies, or various combinations of technologies and, when one technology is used for plural of these connections 18A-E, such connections may yet have variations from one another.

The storage carrier 320 may be variously implemented. Preferably the storage carrier 320 is replaceably removable from the system 10. In that case, the interface 340 preferably provides a physical receptacle or other connection for receiving the carrier 320, in addition to providing electrical coupling of the carrier 320 with the processor 12. As examples, the storage carrier 320 may be implemented as a PCMCIA card, a SmartMedia card, a CompactFlash card, a MemoryStick card, MultiMediaCard/Secure Digital card, xD card, or some other commercial or proprietary card, micro hard or optical disk drive, or otherwise.

The system 10 of this FIG. 3 also shows additional storage carriers 322A, 322B, 322C. It is contemplated that one or more of such storage carriers 322A-C may provide a respective data reliability facility encoded compliant with the first data reliability facility DRF1 30. Any one or more of such respective data reliability facilities may be the same as second data reliability facility DRF2 34. On the other hand, any one or more of such respective data reliability facilities may be implemented partly or entirely differently as second data reliability facility DRF2 34. As well, these data reliability facilities may be more or less the same or different than one another. Generally, any such respective data reliability facility is contemplated to be implemented to advance or satisfy the system's engineering constraints, or at least not to conflict with, or unduly impede satisfaction of, those constraints.

It is also contemplated that one or more of such storage carriers 322A-C may provide a respective data reliability facility encoded compliant with a bootstrap data reliability facility (as that term is defined below to refer to facilities such as DRF1), which bootstrap data reliability facility is other than first data reliability facility DRF1 30. That is, the system 10 may provide one or more bootstrap data reliability facilities, each of which may be associated with one or more encoded data reliability facilities, whether such encoded data reliability facilities are located on one or more storage carriers 322A-C, or otherwise in the architecture 14 or system 10.

Although system 10 of FIG. 3 implements a first storage medium via storage carrier 320, it is also contemplated to implement first storage medium 32 as provided in FIG. 1. That is, the system 10 of FIG. 3 is contemplated to implement both first storage medium 32 (not on a storage carrier) and an additional storage medium via storage carrier 320. In this implementation, the additional storage medium of the carrier 320 preferably shares the same, or substantially similar, characteristics as first storage medium 32 (e.g., being relatively unreliable and relatively capacious, and storing a data reliability facility encoding compliant with first data reliability facility 30).

Although not illustrated, it is also contemplated to provide: (a) the system of FIG. 1 by implementing both the first and the second data reliability facilities 30, 32 via one or more storage carriers 320, 322A-C; (b) the system of FIG. 2 by implementing first storage medium 20 via storage carrier 320; and (c) the system of FIG. 2 by implementing both the first and the second data reliability facilities 300, 32 via one or more storage carriers 320, 322A-C. Each of these three implementations may be provided with or without maintaining all structures of respective systems of FIGS. 1 and 2.

It is also contemplated, when employing a storage carrier for storing data compliant with a particular data reliability facility, to encode and/or decode that data using a version of that facility provided other than on the carrier. As an example, the version used to encode/decode may be resident in the system to which the carrier is introduced. This feature is contemplated notwithstanding the availability of the facility on the carrier. This feature may be supported and triggered for various purposes, including, as examples, to improve speed in the encoding/decoding process.

In another aspect, the first data reliability facility may be considered a bootstrap data reliability facility. In turn, the second data reliability facility may be considered a primary data reliability facility. In this application, the terms “bootstrap” and “primary” are used to convey that the first facility to be executed provides for (bootstraps) the second facility's execution and the second facility is used for encoding/decoding data. As previously described, however, it is contemplated that a bootstrap data reliability facility may be enabled to decode and/or encode data, other than that data related to providing another data reliability facility.

Moreover, these terms “bootstrap” and “primary” are not used to convey, and are not to be interpreted to convey, any qualification, modification or other limitation as to the performance characteristics of any data reliability facility. In that regard, it is understood that the primary data reliability facility may be more or less able to detect and correct data errors than the bootstrap facility. As well, it is understood that the primary data reliability facility may otherwise perform better or worse than the bootstrap facility against one or more other performance parameters associated with such facilities (e.g., speed, redundancy added in encoding data files, storage size of the facility). It is further understood that each such facility preferably is selected to deliver against its respective functions and purposes, toward satisfying the engineering constraint of the system.

In another example embodiment of a system in accordance with this application, it is contemplated to provide a relatively simple first data reliability facility (sometimes referenced hereinafter as a bootstrap decoder). In execution, the bootstrap decoder reads and decodes a small piece of data stored in NAND flash memory. The output of this decoder's execution is a program stored in memory work space (e.g., in some form of RAM). This stored program comprises a second data reliability facility, e.g., a primary decoder. The primary decoder, in execution, reads and corrects errors in additional data stored compliant with the primary decoder, e.g., in any of the system's unreliable memory.

Specifically, the primary decoder reads and corrects errors in the system's software, while providing error correction as to the data inputs/outputs of that software and otherwise as to the system's functions.

In this example embodiment, due to its extreme simplicity, the first data reliability facility can be implemented in software which is stored as a very small program in some reliable, non-volatile storage function (e.g., in ROM, PROM, NOR flash memory or the like). In the alternative, the facility may be implemented in hardware (e.g., as a stand alone circuit, or as part of another chip or module). In either case, the relative simplicity of the facility preferably consumes an insignificant portion of at least selected scarce resources associated with the system (e.g., storage capacity of a non-volatile, relatively reliable, relatively expensive storage medium).

In this embodiment, the costs associated with storage/chip consumption are addressed (e.g., bootstrap facility storage consumption*cost per bit or cost per unit chip area). As well, reliable memory space is preserved for other uses (e.g., storing other data, including programs). And, of course, data reliability is provided.

In another example embodiment, the system comprises a CD changer for an automobile. The system includes 128 megabytes (MB) of NAND flash memory, of which 4 MB are reserved for the system's software. The primary decoder is a bounded minimum distance decoder for a shortened Reed-Solomon code, protecting 512 bytes of information (a “page”) by adding 16 bytes of redundancy. This primary decoder consumes about 8 kilobytes (KB), or less, of storage space.

The primary decoder is stored in the NAND flash memory compliant with a bootstrap decoder. In this example, compliance calls for copying the primary decoder into the memory a predetermined number of times (e.g., storing 5 copies).

The bootstrap decoder reads the copies and decodes by “majority voting”. That is, the bootstrap decoder corrects data errors in the primary decoder by selecting each bit as the majority value of its plural copies. Where 5 copies are stored, a bit's value is determined if one value is found 3 or more times across the copies.

This bootstrap decoder preferably is stored in a reliable, non-volatile storage medium. As an example, it may be stored in NOR flash memory, in ROM, on a reliable micro hard or optical disk drive, or otherwise.

As described above, the bootstrap decoder preferably consumes approximately a few hundred bytes, or possibly even less, of the reliable storage medium. When otherwise implemented, the bootstrap decoder may consume greater or lesser of the storage medium's capacity.

In another example embodiment, the bootstrap decoder effects an algorithm (in hardware, software, or otherwise) that efficiently decodes data stored in software encoded compliant with a selected repetition code. To illustrate, an example of the algorithm works as follows: (a) assuming each bit of the encoded data is encoded by being repeated 5 times, and that the bits are organized in 32-bit words; (b) if 3 of the 5 stored copies of a word are found by the decoder to agree, then the majority vote for each bit in the entire word is determined to be known without the decoder looking at the remaining 2 copies. This algorithm may be employed in that it is understood, for a system in accordance with this application, probabilities are relatively high that the first 3 of the 5 copies will agree.

The algorithm is described in pseudo-code, as follows:

for all words do

x1 := ‘read 1st copy of the word’;
x2 := ‘read 2nd copy of the word’;
x3 := ‘read 3rd copy of the word’;
if x1 = x2 = x3 then /* very likely */

‘output x1 as decoded 32-bit word’

else

x4 := ‘read 4th copy of the word’;
x5 := ‘read 5th copy of the word’;
for i = 0..31 do

if bit(i,x1) + bit(i,x2) + bit(i,x3) +

bit(i,x4) + bit(i,x5) >= 3

then

‘output 1 as decoded i-th bit of the word’

else

‘output 0 as decoded i-th bit of the word’

end if

end for

end if

end for

Various advantages attend the above algorithm for decoding a repetition code with N copies (N an odd integer). Examples of these advantages include: (a) the algorithm looks at (N+1)/2 of the N copies in many, and typically most, cases; (b) when agreement is found from looking at (N+1)12 copies, the remaining (N−1)/2 copies are generally not retrieved, any of which retrieval may be a relatively slow and/or costly process for certain media, such as due to the external interfaces associated with NAND flash memory; and (c) the algorithm decodes an entire word with (N−1)/2 comparison operations in many, and typically most, cases (i.e., in relatively few cases will the algorithm process the data bit by bit). In another example embodiment, bootstrapping of data reliability facilities is iterative. That is, a first bootstrap data reliability facility may extract a second bootstrap data reliability facility, the second bootstrap data reliability facility may extract a third bootstrap data reliability facility, and so on. Whatever implementation, each bootstrap data reliability facility preferably is selected so as to provide reliable extraction of the next data reliability facility and so on, until, ultimately, all data reliability facilities have been extracted. Indeed, one or more of such bootstrap data reliability facilities may be employed not only to extract another data reliability facility, but also to provide reliability for data employed in the system (e.g., to perform as a primary data reliability facility).

In another example embodiment, a bootstrap data reliability facility extracts more than one primary data reliability facilities. To illustrate, one such primary data reliability facility may be employed with respect to music data (e.g., providing relatively fast operation) and another such facility may be employed with respect to file system administrative information (e.g., providing relatively enhanced reliability). To illustrate further, two different facilities may be employed for the same type of data files. For example, each such facility may be employed to deliver against selected—but typically differing in one or more respects—features (e.g., as to a music file, one facility performs faster, while the other facility delivers greater data integrity). In another alternative illustration, each such facility may be proprietary to a particular third party, and support for each facility may be required in order for the system to support the respective third party's specific product (e.g., competing media software solutions). Stated generally, each such facility is employed toward satisfying engineering constraints of the system, including the constraints of the above illustrations, as well other selected constraints, and combinations of any such constraints.

Persons skilled in the art will recognize that many modifications and variations are possible in the details, materials, and arrangements of the parts and actions which have been described and illustrated in order to explain the nature of the subject matter of this application, and that such modifications and variations do not depart from the spirit and scope of the teachings and claims of this application.

1. A storage architecture for storing data in connection with a system, the storage architecture comprising: a first data reliability facility; a second data reliability facility, the second data reliability facility being encoded compliant with the first data reliability facility; and a first storage medium (20), the first storage medium storing the second data reliability facility.

2. A storage architecture as claimed in claim 1, wherein the first data reliability facility is implemented in hardware.

3. A storage architecture as claimed in claim 2, wherein the first data reliability facility is implemented in one of the first storage medium, the storage architecture, or the system.

4. A storage architecture as claimed in claim 1, wherein the first data reliability facility is implemented in software, and further comprising a second storage medium, the second storage medium storing the first data reliability facility.

5. A storage architecture as claimed in claim 4, wherein the first storage medium is unreliable relative to the second storage medium.

6. A storage architecture as claimed in claim 1, wherein the first storage medium provides storage capacity in conformity with the engineering constraints of the system.

7. A storage architecture as claimed in claim 6, wherein the first storage medium comprises NAND flash memory.

8. A storage architecture as claimed in claim 1, further comprising a third data reliability facility, the second and third data reliability facilities being employed toward satisfying respective engineering constraints of the system.

9. A storage architecture as claimed in claim 1, wherein the first and second data reliability facilities comprise respective algorithms, the algorithm of the first data reliability facility being characterized by lesser storage consumption than the algorithm of the second data reliability facility.

10. A storage architecture as claimed in claim 1, wherein the second data reliability facility comprises a codec for at least one of encoding or decoding data.

11. A storage architecture as claimed in claim 10, wherein the second data reliability facility comprises a codec supporting a selected Reed-Solomon code.

12. A storage architecture as claimed in claim 10, wherein the second data reliability facility is encoded compliant with the first data reliability facility by being stored in selected plural copies in the first storage medium, and the first data reliability facility comprises a decoder for correcting data errors in the second data reliability facility by selecting each bit as the majority value of its plural copies.

13. A storage architecture as claimed in claim 10, wherein the first data reliability facility comprises a codec for at least one of encoding or decoding data, such data including at least one of the second data reliability facility other data.

14. A storage architecture as claimed in claim 1, further comprising a storage carrier, the storage carrier comprising the first storage medium and being replaceably removable from the system.

15. A storage architecture as claimed in claim 14, wherein the storage carrier comprises the first data reliability facility.

16. A storage carrier, the storage carrier being replaceably removable from a system, the storage carrier comprising: a first storage medium; a primary data reliability facility, the primary data reliability facility being stored in the first storage medium, and being encoded compliant with a bootstrap data reliability facility.

17. A storage carrier as claimed in claim 16, wherein the second data reliability facility is provided in the storage carrier.

18. A storage carrier as claimed in claim 16, wherein the second data reliability facility is provided in the system.

19. A method for enabling the provision of reliable data from data stored in an unreliable storage medium, the method comprising: providing a bootstrap data reliability facility; providing a first primary data reliability facility in an unreliable storage medium, the first primary data reliability facility being encoded compliant with the bootstrap data reliability facility; and decoding the first primary data reliability facility using the bootstrap data reliability facility so as to enable use of the facility in decoding data from the unreliable storage.

20. A method as claimed in claim 19, wherein the step of providing a bootstrap data reliability facility comprises using at least one of a software-implemented bootstrap data reliability facility stored in a reliable storage medium or a hardware-implemented bootstrap data reliability facility.

21. A method as claimed in claim 19, further comprising: providing a second primary data reliability facility, wherein the second data reliability facility is encoded compliant with one of the bootstrap reliability facility or the first primary data reliability facility; and, decoding the second primary data reliability facility using one of the bootstrap reliability facility or the first primary data reliability facility, so as to enable use of the facility in decoding data from the unreliable storage.
